(19) United States
(12) Patent Application Publication
(10) Pub. No.: US 2005/0217407 A1
(43) Pub. Date: Oct. 6, 2005

(54) Steering apparatus for vehicles

(75) Inventor: Mitsuji Yamamura, Hamamatsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJIKIKO KABUSHIKI KAISHA, Kosai-shi (JP)

(21) Appl. No.: 11/090,022

(22) Filed: Mar. 28, 2005

(30) Foreign Application Priority Data
Mar. 30, 2004 (JP) 2004-099045

(51) Int. Cl. B62D 1/16

(52) U.S. Cl. 74/492

(57) ABSTRACT

A steering apparatus (1) for vehicles capable of undergoing at least telescopic movement is proposed which enables substantial weight and cost reduction through shortening of the overlap (L′) of a movable jacket (7) with a base jacket (6) without affecting the high support rigidity of the movable jacket; also ricketiness of the movable jacket is removed; the movable jacket is engaged with the base jacket in a manner such that the movable jacket can freely slide, and a first lock assembly (20) locks the telescopic movement in synchronism with a second lock assembly (40) when an operation lever (27) is shifted and these lock assemblies unlock the telescopic movement in synchronism too.

### BACKGROUND OF THE INVENTION

1. Field of the Invention

The present invention relates to steering apparatus for vehicles equipped with a lock mechanism for locking at least the telescopic movement.

2. Description of the Related Art

Among the steering apparatuses for changing the vehicle direction, there are some with which it is possible to adjust the up-and-down tilt angle and/or to telescopically change the length of the steering wheel shaft so as to enable the driver to take a posture most suitable to his or her physique.

FIG. 8 shows an example of such tilt/telescopic type vehicle steering apparatus, which is capable of tilt movement and telescopic movement (ref. patent related document 1).

FIG. 8 is a half cross-sectional side view of a conventional steering apparatus 101 for vehicles, wherein reference numeral 102 designates a steering shaft passed inside a cylindrical steering column 105, and this steering shaft 102 comprises an upper shaft 103 and a lower shaft 104, which are spline-fitted such that they are freely slidable in the axial directions. Incidentally, a steering wheel, not shown, is fixed at the upper end of the upper shaft 3.

Also, the steering column 105 has its movable jacket 107 inserted in a base jacket 106, which is attached to the vehicle body, in a manner such that the movable jacket 107 is capable of sliding in the directions along the column axis, and the upper shaft 103 of the steering shaft 102 is held in the movable jacket 107 in a manner such that the upper shaft 103 is freely rotatable about its axis by virtue of a bearing 109, and the lower shaft 104 of the steering shaft 102 is held in the base jacket 106 in a manner such that the lower shaft 104 is freely rotatable about its axis by virtue of a bearing 110.

The base jacket 106 is pivotally connected to brackets 113 and 115 via a bolt 114 in a manner such that the base jacket 106 is capable of swinging up and down, and the upper end portion of the bracket 113 is formed integrally with a pair of left and right parallel side plate portions 113a, which extend downwards. This pair of side plate portions 113a of the bracket 113 cooperatively sandwich between them a clamp member 124, which is fixed to the movable jacket 107, from outside, and each side plate portion 113a is formed with a tilt adjustment slot 123, which is elongated in upward and downward directions.

A tilt bolt 126 is passed through the tilt adjustment slots 123 bored through the side plate portions 113a of the bracket 113 and circular holes, not shown, bored through the clamp member 124, and one end of an operation lever 127 locked to the tilt bolt 126. Incidentally, although it is not shown in FIG. 1, a cam lock assembly is installed on the tilt bolt 126 between the operation lever 127 and the bracket 113.

Thus, the bracket 113, the clamp member 124, the tilt bolt 126, the operation lever 127, the cam lock assembly, and others, not shown, constitute a tilt/telescopic lock means, and when the operation lever 127 is turned to increase the distance between the side plate portions 113a of the bracket 113 by virtue of the cam lock assembly, the bracket 113 ceases to clamp the clamp member 124 and the clamp member 124 ceases to clamp the movable jacket 107 whereby the lock means is unlocked and it becomes possible to effect the telescopic movement of the steering wheel by shifting the movable jacket 107 together with the upper shaft 103 of the steering shaft 102 in the axial directions, and also it becomes possible to effect the tilt movement of the steering wheel by swinging up and down the steering column 105 and the steering shaft 102 about the bolt 114, this swinging being limited to an extent corresponding to the limited range of the movement of the tilt bolt 126 within the tilt adjustment slot 123 of the bracket 113.

Then, after the desired telescopic movement and the tilt movement for adjustment are completed, as described above, the operation lever 127 is turned back, whereupon the cam lock assembly works to decrease the distance between the side plate portions 113a of the bracket 113 with the result that the bracket 113 clamps the clamp member 124 and the clamp member 124 clamps the movable jacket 107; thus, the lock means is in locking operation and consequently the steering shaft 102 is prevented from making any further telescopic movement as well as tilt movement, and thus the steering wheel stays at the up-and-down tilt angle and the axial position as of the adjustment.

Admitted prior art: Japanese pre-Patent Publication 2001-347953

However, in the above-described conventional steering apparatus 101 for vehicles, the length L′, which is the overlap length by which the movable jacket 107 extends in the base jacket 106, had always to be substantially great in order to secure a high support rigidity of the movable jacket 107 of the steering column 105; as a result, the lengths of the base jacket 106 and the movable jacket 107 tended to be undesirably great and this prevented weight and cost reduction of the steering apparatus 101.

Also, in order to prevent ricketiness at the overlapping between the base jacket 106 and the movable jacket 107, it was necessary to permanently press the movable jacket 107 upon one side part of the inner wall of the base jacket 106, so that at the time of telescopic movement the sliding friction of the movable jacket 107 got so great that it taxed driver's arms.

### SUMMARY OF THE INVENTION

The present invention was made in view of the afore-mentioned problems, and it is an object of the invention to propose a steering apparatus for vehicles, which enables substantial weight and cost reduction through shortening of the overlap between the movable jacket and the base jacket without affecting the high support rigidity of the movable jacket of the steering column, and also the proposed steering apparatus does not experience ricketiness at the overlap between the two jackets while the sliding friction of the movable jacket at the time of the telescopic movement is reduced.

In order to attain the above-described object, the invention as claimed in Claim 1 is characterized by that a steering apparatus for vehicles capable of undergoing at least telescopic movement comprises a steering column, a base jacket attached to the vehicle body, a movable jacket engaged with the base jacket in a manner such that the movable jacket can freely slide in directions of the axis of the steering column, a first lock assembly, a second lock assembly, an operation lever, and a link for interconnecting the first lock assembly to the second lock assembly in a manner such that these assemblies lock the telescopic movement in synchronism by preventing the movable jacket from sliding when the operation lever is shifted in a predetermined direction.

The invention as claimed in Claim 2 is characterized by that, further to the invention as claimed in Claim 1, the steering apparatus for vehicles further comprises a cam lock subassembly in the first lock assembly, an adjust bracket fixed to the vehicle body, a distance bracket fixed to the movable jacket, and a first bolt inserted through both of these brackets and disposed to turn together with the operation lever, wherein the first lock assembly is constructed in a manner such that the adjust bracket embraces the distance bracket and such that a turning by the operation lever of the first bolt drives the cam lock subassembly whereby the adjust bracket either strengthens or loosens its embrace of the distance bracket to selectively effect locking and unlocking of the telescopic movement at the first lock assembly.

The invention as claimed in Claim 3 is characterized by that, further to the invention as claimed in Claim 1, the steering apparatus for vehicles further comprises a fixture means (41, 42) fixed to the stationary bracket, a second bolt threadably engaged with this fixture means and disposed to be turned in synchronism with the first bolt, and a flexible collar provided between the stationary bracket and the movable bracket, wherein the second lock assembly is provided at a junction where the base jacket and the movable jacket are engaged with each other, and a turning of the second bolt causes the second bolt to proceed or recede in the direction orthogonal to the steering column axis to start or stop deforming the flexible collar whereupon locking and unlocking of the telescopic movement at the second lock assembly is selectively effected.

The invention as claimed in Claim 4 is characterized by that, further to the invention as claimed in Claim 3, the flexible collar has a plurality of thick parts, which have thicknesses greater than the other parts and are separated from each other in circumferential direction.

The invention as claimed in Claim 5 is characterized by that, further to the invention as claimed in and one of Claims 1 through, the base jacket is adapted to swing upward and downward about its lower end portion where it is pivotally attached to the vehicle body, and the first lock assembly is adapted to lock the tilt movement simultaneously as it locks the telescopic movement and also to unlock the tilt movement simultaneously as it unlocks the telescopic movement.

According to the inventions of Claims 1 to 3, a first lock assembly is interconnected to a second lock assembly via a link such that it is possible to cause both of these lock assemblies to lock/unlock the telescopic movement through single shifting of the operation lever, thus operation becomes simpler. Also, since two lock assemblies are provided as the lock means for locking at least the telescopic movement, the movable jacket is supported by these two lock assemblies, and thus the support rigidness is increased, whereby the distance by which the movable jacket is inserted in the base jacket can be much reduced from that in a conventional steering apparatus, and thus it is possible to reduce the weight and the manufacturing cost of the steering apparatus. Furthermore, as one of the lock assemblies is provided at the junction where the base jacket engages with the movable jacket, it is possible to support the movable jacket with this lock assembly so that the ricketiness is prevented at this junction, and during the telescopic movement, since this lock assembly is unlocked, the sliding friction on the movable jacket is minimized so that easy telescopic movement is possible.

According to the invention of Claim 4, since the flexible collar provided between the stationary bracket and the movable bracket has a plurality of parts thicker than the other parts and separated from each other in circumferential direction, the resin collar presses upon the movable jacket especially strongly at these thicker parts so that sliding movement of the movable jacket is effectively forbidden and a reliable lock is established, and also the movable jacket is caused to firmly press on the base jacket whereby any rickety movement between these jackets is nullified.

According to the invention of Claim 5, in the case of a tilt/telescopic type vehicle steering apparatus, which is capable of tilt movement and telescopic movement, it is now possible to simultaneously lock or unlock the telescopic movement and the tilt movement by one-touch shifting of the operation lever.

### BRIEF DESCRIPTION OF THE DRAWINGS

The features and advantages of the present invention will become more clearly appreciated from the following description taken in conjunction with the accompanying drawings in which:

FIG. 1 is a partially cross-sectional side view of a steering apparatus for vehicles according to the present invention;

FIG. 2 is an enlarged cross-sectional view taken along the line A-A of FIG. 1;

FIG. 3 is an enlarged cross-sectional view taken along the line B-B of FIG. 1;

FIG. 4 is a view as seen in the direction of the arrow C of FIG. 3;

FIG. 5 is an enlarged cross-sectional view taken along the line D-D of FIG. 1;

FIG. 6 is a half cross-sectional side view of a resin collar;

FIG. 7 is a cross-sectional view taken along the line E-E of FIG. 6; and

FIG. 8 is a half cross-sectional side view of a conventional steering apparatus for vehicles.

### DETAILED DESCRIPTION OF THE PREFERRED EMBODIMENTS

Some embodiments of the present invention will be explained here with reference to the attached drawings.

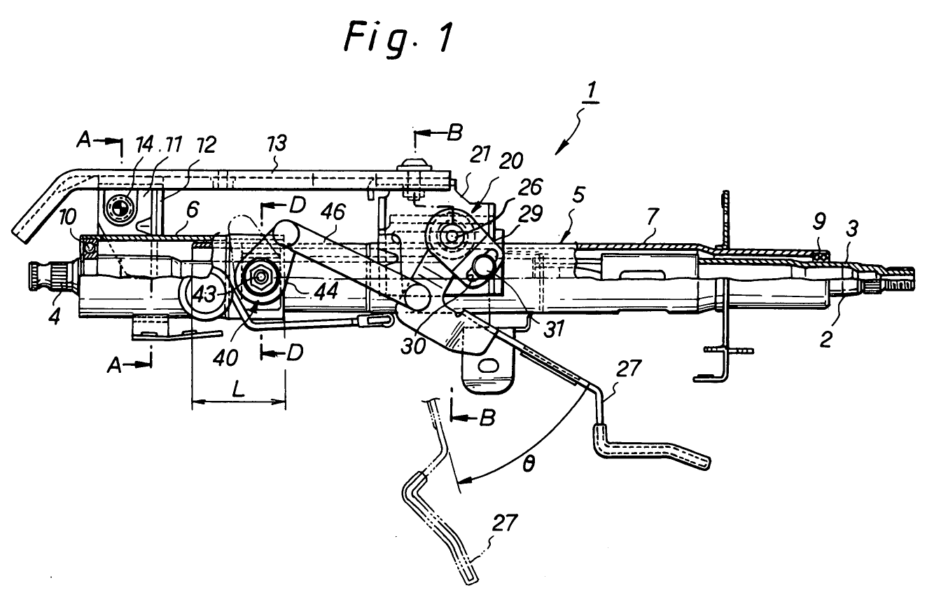

In a steering apparatus 1 for vehicles shown in FIG. 1, a reference numeral 2 designates a steering shaft inserted in a cylindrical steering column 5, and this steering shaft 2 is constituted by an upper shaft 3 and a lower shaft 4, which are spline-fitted in the steering column 5 such that they are freely slidable in the axial directions. Incidentally, a steering wheel, not shown, is fixed at an upper end of the upper shaft 3, and a lower end of the lower shaft 4 is connected to a steering gear box, not shown either, via an adjustable joint, nor shown.

Also, the steering column 5 has its movable jacket 7 inserted in a base jacket 6, which is attached to the vehicle body, in a manner such that the movable jacket 7 is capable of sliding on a resin collar 8, shown in FIG. 5, in the directions along the column axis, and the upper shaft 3 of the steering shaft 2 is held in the movable jacket 7 in a manner such that the upper shaft 3 is freely rotatable about its axis by virtue of a bearing 9, and the lower shaft 4 of the steering shaft 2 is held in the base jacket 6 in a manner such that the lower shaft 4 is freely rotatable about its axis by virtue of a bearing 10.

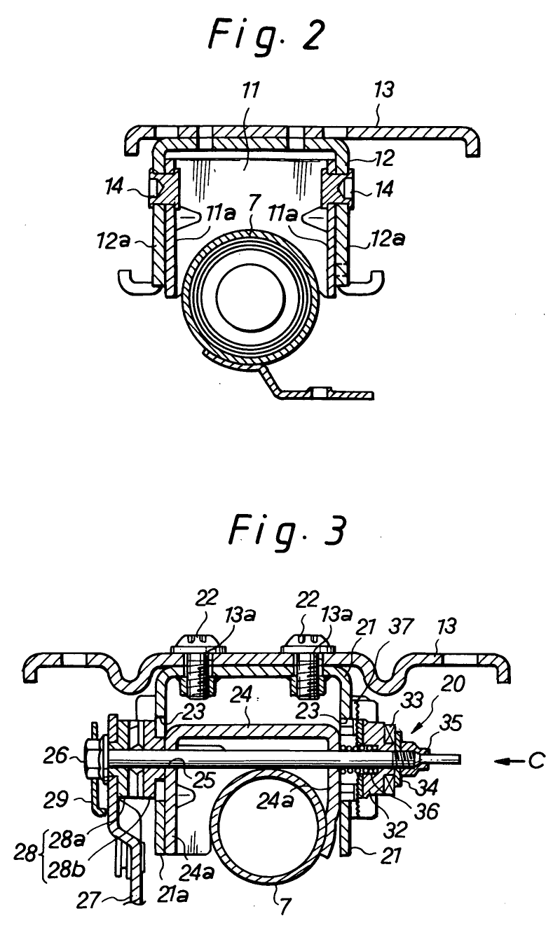

Now, a channeled bracket 11, which has a channel on one side, is welded to an outer circumference surface of a lower part of the base jacket 6, as shown in FIG. 1 and FIG. 2, and a pair of parallel side plates 11a, 11a of the bracket 11 are firmly caught in a bracket 12 having a cross section of a letter “U”, with the open side facing downward, as seen in FIG. 2, and this bracket 12 is attached to a vehicle-side bracket 13, which is connected to the vehicle body. Next, the bracket 12 is connected to a pair of tilt hinges 14, in a manner such that each tilt hinge 14 penetrates the corresponding side plate 12a of the bracket 12 and the corresponding side plate 11a of the bracket 11 and such that the bracket 12 is capable of freely turning about the tilt hinges 14; hence, the movable jacket 7 (or the steering column 5 and the steering shaft 2) is held in the vehicle in a manner such that it can swing upward and downward about its rear end portion where the tilt hinges 14 penetrate it.

In this particular embodiment, a first lock assembly 20 and a second lock assembly 40, as lock means for the tilt/telescopic movement, are provided at two locations along the axis of the steering column 5, and, as will be described later, the first lock assembly 20 is disposed to lock and unlock the tilt and telescopic movements and the second lock assembly 40 is disposed to lock and unlock the telescopic movement.

Now, the construction of the first lock assembly 20 will be explained with reference to FIGS. 1, 3, and 4.

At an upper end portion of the vehicle-side bracket 13 is fixed a U letter-shaped adjust bracket 21 with a pair of bolts 22, 22 in such a manner that the letter U opens downwards; through each of a pair of parallel side plate portions 21a, 21a of this adjust bracket 21 is formed a vertically elongated tilt adjustment slot 23. Incidentally, the bolts 22 are inserted through slots 13a, respectively, which are formed in the vehicle-side bracket 13 and are elongated in the direction of the vehicle length (that is, the fore-and-aft direction of the vehicle), and this collapsible or deformable construction allows movement of the adjust bracket 21 toward the vehicle front at the time of secondary shock thereby effecting absorption and softening of the shock.

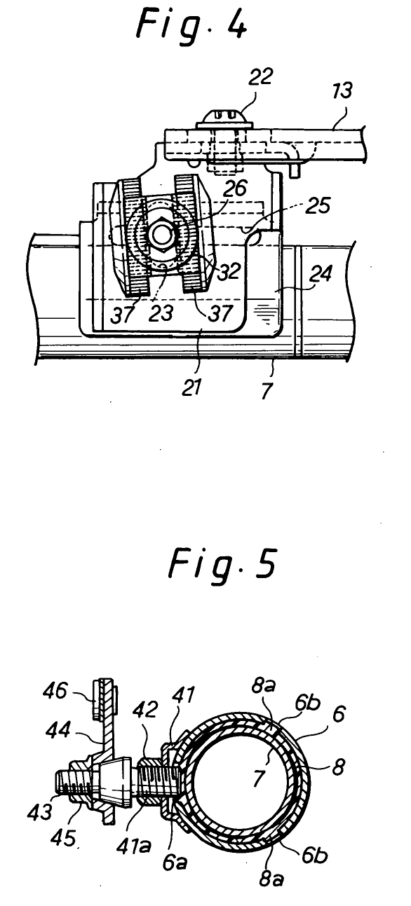

Also, on the circumferential surface of the movable jacket 7 of the steering column 5 is welded a U letter-shaped distance bracket 24 in a manner such that the letter U opens downward, and through each of a pair of parallel side plates 24a, 24a of this bracket 24 is formed a telescopic slot 25, which is elongated in the direction of the vehicle length (or in the direction of the column axis line, ref. FIG. 4).

Thus, the adjust bracket 21 fits on the distance bracket 24 from outside as each one of the side plate portions 24a of the distance bracket 24 is closely touched by the respective side plate portions 21a of the adjust bracket 21, and a tilt bolt 26 is passed through the tilt adjustment slot 23 formed through the adjust bracket 21 and the telescopic slot 25 formed through the distance bracket 24. Therefore, the movable jacket 7 is installed in a manner such that it can move in the direction of the vehicle length (or in the direction of the column axis line) together with the upper shaft 3 through a distance equal to the distance through which the tilt bolt 26 can move in the telescopic slot 25, whereby a telescopic motion (or tilt adjustment) of the steering wheel, not shown, is enabled.

Incidentally, as shown in FIG. 3, an operation lever 27 and a cam lock subassembly 28 are engaged between a head portion of the tilt bolt 26 and one of the side plate portions 21a of the adjust bracket 21, and the operation lever 27 has one of its ends penetrated by the tilt bolt 26. Now, the head portion of the tilt bolt 26 is engaged with a plate stopper 29, and, as shown in FIG. 1, when a bolt 31 inserted through an arc-shaped slot 30 formed through the stopper 29 is screwed to threadably engage with the operation lever 27, the operation lever 27 becomes fixed to the tilt bolt 26 such that these two turn together as one body, and also it becomes possible to restrict the position of the operation lever 27 to such limits corresponding to the range of movement of the bolt 31 within the slot 30 of the stopper 29.

Now, the cam lock subassembly 28 is composed of, as shown in FIG. 3, a movable cam lock member 28a disposed to turn together with the tilt bolt 26 and a stationary cam member 28b engaged with the tilt adjustment slot 23 bored through the adjust bracket 21, and the movable cam lock member 28a and the stationary cam member 28b are engaged with each other via their concavo-convex cams formed on the respective faces facing each other.

On the other hand, a locking block 32 is provided on the other end (tail end) portion of the tilt bolt 26, which extends past the other side plate portion 21a of the adjust bracket 21, in a manner such that the locking block 32 is capable of sliding on the tilt bolt 26, and this locking block 32 is stopped by a nut 35 via a thrust bearing 33 and a washer 34 from moving off the tilt bolt 26 and at the same time the block 32 is permanently urged toward the tail end of the tilt bolt by a spring 36.

Also, at the other side of the tilt adjustment slot 23 of the side plate portion 21a of the adjust bracket 21 are formed two rows of tilt lock cogs 37 (ref. FIG. 4), and these tilt lock cogs 37 are selectively engaged with lock cogs formed on the locking block 32.

Hence, the steering column 5 and the steering shaft 2 inserted therein are capable of swinging up and down about the tilt hinges 14 (ref. FIG. 1 and FIG. 2) to an extent corresponding to the limited range of movement of the tilt bolt 26 (or more precisely the stationary cam member 28b of the cam lock subassembly 28) within the tilt adjustment slot 23, and by virtue of these swinging movements the upward and downward tilting position of the steering wheel, not shown, is adjustable.

Next, the construction of the second lock assembly 40 will be explained with reference to FIG. 1 and FIG. 5.

As is shown in FIG. 5, through a side portion of the base jacket 6 is bored a circular hole 6a, and a bracket 41 is welded onto the outer circumferential surface of the base jacket 6 to surround the circular hole 6a. And a circular hole 41a is bored through this bracket 41, and a nut 42 is welded to the bracket 41 coaxially with this hole 41a.

Thus, a telescopic bolt 43 is threadably engaged with the nut 42, and the fore end of the telescopic bolt 43 is passed through the circular hole 41a bored through the bracket 41 and is abuttable against a part of the resin collar 8.

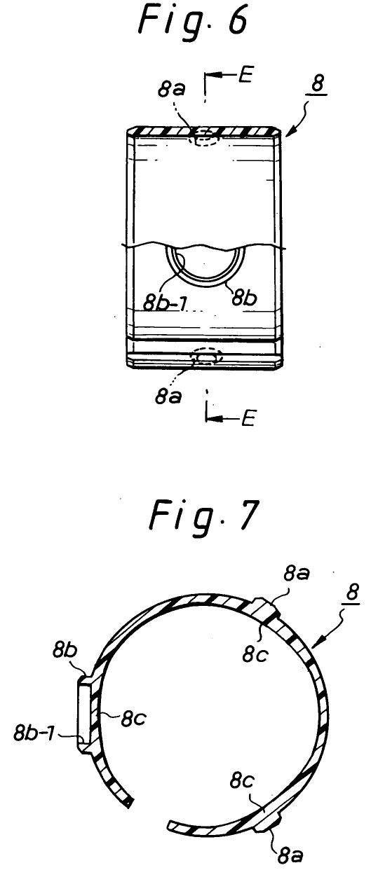

Here, the resin collar 8, as shown in FIG. 6 and FIG. 7, is monoblock-casted of a flexible resin in a shape of cut-away ring, and its outer circumference has two small columnar protrusions 8a, 8a and one large columnar protrusion 8b, and as these protrusions 8a and 8b engage with the circular bores 6b, 6a of the base jacket 6, respectively, the resin collar 8 is firmly held to the base jacket 6. Then, a circular hole 8b-1 is formed centrally in the protrusion 8b, and this circular hole 8b-1 receives and engages with the fore end of the telescopic bolt 43.

Also, as shown in FIG. 7, the resin collar 8 has thick parts 8c, 8c, 8c, which have thicknesses greater than the other parts, at three circumferentially equidistant positions of the collar (in this embodiment at the positions where protrusions 8a, 8a and 8b are formed).

On the other hand, as shown in FIG. 1 and FIG. 5, one end of a sub-lever 44 is connected to the telescopic bolt 43 via a nut 45, and the other end of the sub-lever 44 and a middle part of the operation lever 27 are interconnected to each other via a link 46.

Next will be explained the telescopic movement of the vehicle steering apparatus 1 of the present invention, and also will be explained its lock/unlock mechanism.

When the operation lever 27 is in the lock position as depicted in solid line in FIG. 1, the first lock assembly 20 and the second lock assembly 40 are disposed to take respective lock positions.

In other words, since in the first lock assembly 20, the movable cam member 28a of the cam lock subassembly 28 and the cam of the stationary cam member 28a engage with each other by their respective convex portions, the tilt bolt 26 is displaced in an axial direction (leftward as viewed in FIG. 3), and as a result, the side plate portions 21a, which are monolithic parts of the adjust bracket 21, are squeezed to decrease the distance between themselves, whereupon they compress the side plate portions 24a of the distance bracket 24 inwardly to thereby clasp them firmly. Consequently, a high friction is created between the side plate portions 21a of the adjust bracket 21 on one hand and the side plate portions 24a of the distance bracket 24 on the other, and this friction prevents the movable jacket 7 and the upper shaft 3 from sliding in the directions of the column axis.

Also, as described above, when the tilt bolt 26 is axially displaced, the locking block 32 is urged against the tilt lock cogs 37 formed on the adjust bracket 21, so that the lock cogs of the locking block 32 fall in engagement with the tilt lock cogs 37, whereby the swing movement of the steering column 5 and the steering shaft 2 about the tilt hinges 14 is prevented and thus the tilt movement of the steering wheel is forbidden.

Incidentally, in this embodiment, lock cogs are employed as the tilt lock means, but it is also possible to employ lock cogs for telescopic movement and to lock the telescopic system too by causing these lock cogs to go past the tilt adjustment slot 23 of the adjust bracket 21 to engage with lock cogs which are provided along the border of the telescopic slot 25 of the distance bracket 24. Furthermore, it is also possible to omit the tilt lock cogs, and to lock the tilt mechanism by employing the friction between the adjust bracket 21 and the distance bracket 24.

Now, turning to the second lock assembly 40, when the operation lever 27 is taking the position drawn in solid line in FIG. 1, the sub-lever 44 interconnected to the operation lever 27 also takes the position drawn in the solid line in FIG. 1, and at this time since the telescopic bolt 43 presses upon the resin collar 8 at its fore end, the resin collar 8 clasps upon the outer circumference of the movable jacket 7 so firmly that the movable jacket 7 is prevented from shifting in the directions of the column axis. Incidentally, as described above, since the resin collar 8 has three thick parts 8c formed equidistantly along the circumference, the resin collar 8 presses upon the movable jacket 7 especially strongly at these thick parts 8c so that sliding movement of the movable jacket 7 is effectively forbidden and a reliable lock is established, and also the movable jacket 7 is caused to firmly press on the base jacket 6 whereby any rickety movement between the jackets 6 and 7 is nullified.

Braked both at the first lock assembly 20 and the second lock assembly 40, the movable jacket 7 and the upper shaft 3 are prevented from sliding in the directions of column axis, and thus the telescopic movement of the steering wheel is locked.

Next, when it is desired to obtain up-and-down swinging (tilting) movement and expansion-and-contraction (telescopic) movement of the steering wheel for adjustment thereof, the operation lever 27 taking the position drawn in the solid line in FIG. 1 is turned clock-wise through an angle θ to take the position drawn in two-dot chain line, whereupon the sub-lever 44, which is interconnected to the operation lever 27 via the link 46, is caused to turn from the position of solid line to the position of two-dot line; as a result both the first lock assembly 20 and the second lock assembly 40 are brought into their unlock postures.

In other words, at the first lock assembly 20, the tilt bolt 26 and the movable cam member 28a of the cam lock subassembly 28 are simultaneously turned in one body with the operation lever 27, whereupon engagement between the movable cam member 28a and the stationary cam member 28b turns from convex-convex to concave-convex; as a result, the tilt bolt 26 is displaced rightward as viewed in FIG. 3. Then, the adjust bracket 21 ceases to clasp the distance bracket 24, whereupon the movable jacket 7 and the upper shaft 3 are allowed to shift in the directions of the column axis. Also, at the same time, since the locking block 32, constantly biased by the spring 36, moves on the tilt bolt 26 in the rightward direction, as viewed in FIG. 3, the lock cogs formed on the locking block 32 leave from the tilt lock cogs 37 of the adjust bracket 21 to disrupt the cog engagement. As a result, the tilt lock is unlocked, and the steering column 5 and the steering shaft 2 are allowed to turn about the tilt hinges 14, so that it is possible to control the up-and-down movement (tilting) of the steering wheel.

On the other hand, at the second lock assembly 40, as the sub-lever 44 turns, the telescopic bolt 43 is caused to simultaneously turn in the same direction, and as the telescopic bolt 43 threadably engaged with the nut 42 recedes leftward, as viewed in FIG. 5, the pressure imposed on the resin collar 8 by the telescopic bolt 43 is removed, and thus the movable jacket 7 and the upper shaft 3 sheathed therein are allowed to move in the directions of the column axis.

Now, as described above, the movements of the movable jacket 7 and the upper shaft 3 in the directions of the column axis are not thwarted at the first lock assembly 20 and the second lock assembly 40, and thus the steering wheel is unlocked and can undergo telescopic movements, whereby it becomes possible to obtain the expansion-and-contraction (telescopic) movement of the steering wheel in the directions of the column axis for lengthwise adjustment.

When the steering wheel is adjusted by tilting it upward or downward and by expanding or contracting it telescopically in the directions of the steering shaft axis while the first lock assembly 20 and the second lock assembly 40 are in their unlock postures, the driver turns the operation lever 27 from the position drawn in two-dot chain line (FIG. 1) to that drawn in solid line, whereupon the first lock assembly 20 and the second lock assembly 40 again assume their lock postures and the steering wheel is locked from tilting upward or downward and from expanding or contracting telescopically in the directions of column axis.

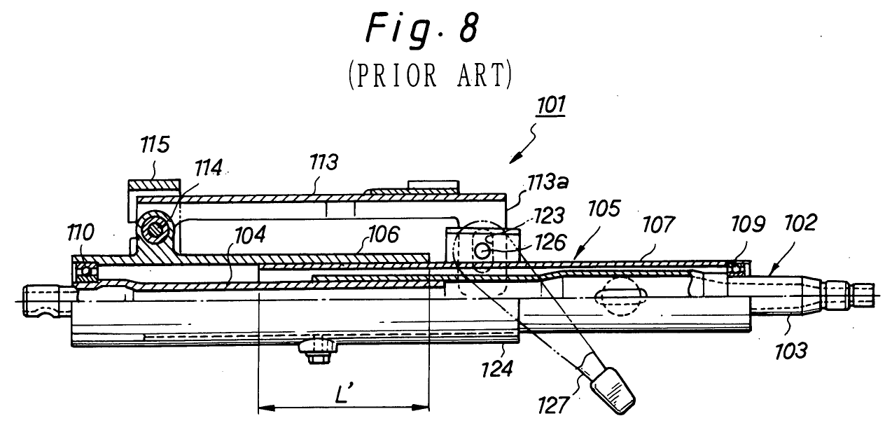

As explained above, in the present embodiment, the first lock assembly 20 and the second lock assembly 40 are provided as the lock means for locking at least the telescopic movement of the movable jacket 7, so that the movable jacket 7 is supported at the lock assembly 20 as well as the lock assembly 40, and thus the support rigidness is increased. Consequently, the insertion length L of the movable jacket 7 in the base jacket 6 (ref. FIG. 1) is much reduced from the insertion length L′ in the case of a conventional steering apparatus 101, shown in FIG. 8, (L<L′), and it is possible to reduce the weight and the manufacturing cost of the steering apparatus 1.

Also, on account of the fact that the second lock assembly 40 is provided at the junction where the base jacket 6 and the movable jacket 7 are engaged with each other, it is possible to support the movable jacket 7 with the second lock assembly 40 so that the ricketiness is prevented at this junction. Furthermore, during the telescopic movement, since the second lock assembly 40 is unlocked, the sliding friction on the movable jacket 7 is minimized so that easy telescopic movement is possible.

In addition, in the case of a tilt/telescopic type vehicle steering apparatus, which is capable of tilt movement and telescopic movement, like the one of the present embodiment, it is possible to simultaneously lock or unlock the telescopic movement and the tilt movement by one-touch shifting of the operation lever 27.

Incidentally, in the vehicle steering apparatus 1 according to the present embodiment, the movable jacket 7 and the distance bracket 24 rush to their foremost positions and then the adjust bracket 21, tilt bolt 26 and the operation lever 27 shift in one body at the time of secondary shock. On this occasion, pressed by the link 46, the sub-lever 44 swings, and the telescopic bolt 43 is unscrewed. Then, as the operation lever 27 is allowed to shift farther, the link 46 is deformed and part of the shock is absorbed therein. Optionally, an energy absorption structure may be provided between the adjust bracket 21 and the vehicle side bracket 13.

### USEFULNESS AND INDUSTRIAL APPLICABILITY

The present invention is applicable to vehicle steering apparatuses capable at least of telescopic adjustment of the steering wheel.

1. A steering apparatus for vehicles capable of undergoing at least telescopic movement comprising: a steering column, a base jacket attached to a vehicle body, a movable jacket engaged with said base jacket in a manner such that said movable jacket can freely slide in directions of the axis of said steering column, a first lock assembly, a second lock assembly, an operation lever, and a link for interconnecting said first lock assembly to said second lock assembly in a manner such that these lock assemblies lock the telescopic movement in synchronism by preventing said movable jacket from sliding when said operation lever is shifted in a predetermined direction and such that these lock assemblies unlock the telescopic movement in synchronism by ceasing to prevent said movable jacket from sliding when said operation lever is shifted in the opposite direction.

2. The steering apparatus for vehicles as claimed in claim 1, further comprising a cam lock subassembly in said first lock assembly, an adjust bracket fixed to the vehicle body, a distance bracket fixed to said movable jacket, and a first bolt inserted through both of these brackets and disposed to turn together with said operation lever, wherein said first lock assembly is constructed in a manner such that said adjust bracket embraces said distance bracket and such that a turning by said operation lever of said first bolt drives said cam lock subassembly whereby said adjust bracket either strengthens or loosens its embrace of said distance bracket to selectively effect locking and unlocking of said telescopic movement at said first lock assembly.

3. The steering apparatus for vehicles as claimed in claim 1, further comprising a fixture means fixed to said stationary bracket, a second bolt threadably engaged with said fixture means and disposed to be turned in synchronism with said first bolt, and a flexible collar provided between said stationary bracket and said movable bracket, wherein said second lock assembly is provided at a junction where said base jacket and said movable jacket are engaged with each other, and a turning of said second bolt causes said second bolt to proceed or recede in the direction orthogonal to said steering column axis to start or stop deforming said flexible collar whereupon locking and unlocking of said telescopic movement at said second lock assembly is selectively effected.

4. The steering apparatus for vehicles as claimed in claim 3, wherein said flexible collar has a plurality of thick parts, which have thicknesses greater than the other parts and are separated from each other in circumferential direction.

5. The steering apparatus for vehicles as claimed in any one of claims 1 through 4, wherein said base jacket is adapted to swing upward and downward about its lower end portion where it is pivotally attached to the vehicle body, and said first lock assembly is adapted to lock the tilt movement simultaneously as it locks the telescopic movement and also to unlock the tilt movement simultaneously as it unlocks the telescopic movement.
